(19) United States
(12) Patent Application Publication
(10) Pub. No.: US 2006/0112111 A1
(43) Pub. Date: May 25, 2006

(54) System and methods for data analysis and trend prediction

(75) Inventors: Belle Tseng, Cupertino, CA (US); Yi Wu, Goleta, CA (US)

Correspondence Address: NEC Laboratories America, Inc., 4 Independence Way, Princeton, NJ, 08540, US

(73) Assignee: NEC Laboratories America, Inc., Princeton, NJ (US)

(21) Appl. No.: 11/086,172

(22) Filed: Mar. 22, 2005

Related U.S. Application Data
(60) Provisional application No. 60/630,050, filed on Nov. 22, 2004.

(51) Int. Cl. G06F 17/30

(52) U.S. Cl. 707/100

(57) ABSTRACT

Systems and methods for data analysis and trend prediction. Multiple networks are combined for analysis to improve the accuracy of the evaluation by broadening the type of criteria considered. Relevant features are extracted from a dataset and at least one network is formed representing various relationships identified among the items contained in the dataset according to heuristics. Statistical analyses are applied to the relationships and the results output to a user via one or more reports to permit a user to evaluate each of the items in the dataset relative to each other. The trend of the relationships may be predicted based on the results of statistical analysis applied to the features over successive discrete time periods.

This application claims the benefit of U.S. Provisional Application No. 60/630,050, filed Nov. 22, 2004, the entire disclosure of which is hereby incorporated by reference as if set forth fully herein.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND

1. Field of the Invention

The present invention relates to the field of data analysis and, more specifically, to methods and systems relating to use and analysis of data relationships.

2. Description of Related Art

Analysis of data compilations, including statistical analysis of relationships in the data and future trend analysis, is an area of wide application. For example, organizations often need to identify a person or group having expertise or skills (e.g., an “expert”) in a particular field for purposes such as recruiting or for engaging the services of the person or group. The process of selecting or recruiting a person or group that possesses certain expertise may also require the organization to evaluate the relative anticipated effectiveness of each particular candidate against others in the field. Thus, multiple factors such as the technical knowledge possessed by the person or expert, standing within the relevant technical community, and the ability to successfully collaborate with others may all be relevant to an organization's process of selecting or recruiting a particular person or expert. Smaller, resource-limited organizations need to quickly identify and select a person or expert from a set of identified candidates with a minimum of time and effort. On the other hand, for larger organizations business effectiveness is often a direct function of the ability to leverage the collaboration relationship and expertise power of a wide network of employees.

For example, the team leader of a new Internet service company may encounter the need to recruit a person or expert to contribute certain technical capabilities to the company. However, the team leader may not be able to find a person or employee with the exact expertise in the current company records or information database match because the required knowledge or experience may be associated with a relatively new technical area (e.g., Web service). In this situation, the team leader may necessarily have to broaden his search criteria to look for a person with good experience in Internet programming more generally. However, the difficulty in evaluating multiple candidates increases as the candidates identified using the broadened criteria possess actual experience and skills that increasingly depart from the ideal desired skill set and experience. In addition to knowledge of which candidate has the most closely-related expertise, a team leader or recruiter also may need to know how well the potential employee has collaborated with others because an employee who cannot function effectively in a group environment is likely to hurt the overall project progress.

In order to assist organizational personnel in identifying and evaluating experts, expertise management systems and methods have been developed. Existing systems and methods for expertise management can be divided into two major categories. The first involves building and using a single user profile. The second involves building associations among a group of users.

Examples of the first category, single user expertise profiles, include those described in U.S. Pat. No. 6,154,783, U.S. Pat. No. 6,253,202, and U.S. Pat. No. 6,377,949. Further examples include the ActionBase™ business collaboration software provided by Kamoon, Inc. of Tel Aviv, Israel, details for which are available on the World Wide Web (“Web”) at www.actionbase.com, as well as the AskMe Enterprise™ software, version 6.5, provided by the AskMe Corporation of Bellevue, Wash., details for which are available on the Web at www.askmecorp.com. These examples may provide expertise search tools such as alphabetical indexing/browsing, string matching in the expert field, and category aggregation. However, these existing expertise-management systems treat the information of each individual independently, and structural linkages among people are destroyed. Thus, there are at least two shortcomings of the existing single-user-profile approach. First, they do not support searching related experts, e.g., “searching reviewers for a journal paper, who have related expertise with this paper's author and don't have a conflict of interest.” Second, they lack the capability to evaluate social aspects. Thus, given a query to search experts from a data set, these single-user-profile systems will check the profile of each expert in the database and return a multitude of people with matched expertise. However, they do not provide the capability to assist the user in judging the relative impact of each expert in a particular field in selecting the best candidate. For example, existing systems cannot support a query such as “search reviewers for a journal paper who have a high impact in data mining community.”

Examples of the second category of existing systems, social network approaches, create associations among a group of users. Social network approaches may include those systems and methods that study explicit relationships among people such as, for example, those described in U.S. Pat. No. 5,008,853 and U.S. Pat. No. 6,175,831. Further examples include the LinkedIn™ service provided by LinkedIn, Ltd. of Mountain View, Calif., details for which are available on the Web at www.linkedin.com.; the Orkut™ service provided by Google, Inc. of Mountain View, Calif., details for which are available on the Web at www.orkut.com; and the Ryze™ business networking service provided by Ryze, Ltd. of St. Peters Port, Guernsey, British Virgin Islands. These systems have been formed to help connect friends and business associates and may be helpful to a user to find employees, clients, and business partners by exploiting the topology of their social network. However, these networks are limited to the people who have signed up for the service. Further, people do not update their profiles frequently. Therefore the information used to provide these services is difficult to keep up-to-date while relying on manual updates by users.

Additional existing social networks focus on studying the implicit relationship among people such as, for example, those described in U.S. Pat. No. 6,594,673, which may provide visualization of relationships or connections in collaborative information relating to network interaction media such as email and email lists, conferencing systems and bulletin boards, chats, multi-user dungeons (MUDs), multi-user games and graphical virtual worlds, etc. Another example of an existing social network is described in Culotta et al., “Extracting Social Networks and Contact Information from Email and the Web,” Conference on Email and Spam (CEAS), 2004, which extracts university and company affiliations from news articles and Web sites to create databases of people searchable by company, job title, and educational history.

Therefore, prior systems and methods lack certain useful capabilities. For example, prior network analysis systems and methods lack the ability for a user to determine the evolution of these networks over time. Indeed, prior systems and methods are focused on the static property of a network. However, the dynamic features of a network provide more insights about the evolutionary pattern of a community and predict its future development trend. Furthermore, while U.S. Patent Application No. 20040128273 describes a method for gathering and recording temporal information for a linked entity, identifying a link related activity within a linked source entity, and recording a time stamp in association with the link related activity, no prior system or method provides for automatically network evolution detection and predicting the future trend of expertise and social relationships.

Furthermore, prior network analysis methods study social connections only. Prior systems and methods do not offer analysis of combined expertise relativity and social connections among people. Moreover, a statistical analysis of correlation between expertise and social behaviors is valuable. For example, it will be helpful for a new researcher to notice the correlation between social behavior and expertise behavior of a well-established person in the community, in order to follow his path to become successful.

Thus, there is a need for expertise-management systems and methods that can provide valuable information of expertise and social relationship based on past events and make recommendations or predictions for on-demand tasks.

### SUMMARY

The present invention is directed generally to providing systems and methods for data analysis. More specifically, embodiments may include systems and methods relating to relationship management. Such embodiments may include, for example, building an expertise management system that accounts for both expertise and social relationships, analyzing expertise and social network evolution correlation, and predicting future trends related thereto. Such embodiments may further include an expertise-social network combination system and method that provides to a user an indication of the expertise relationship of a person or group of interest such as, for example, an expert, and the social relationship among the person or group. Embodiments may also include a system to provide statistics- and learning-based network analysis to detect expertise and social network evolution patterns, find the correlation between expertise and social behavior, make recommendation for recruiting or reviewing, and predict new trends for the whole community or individual's future behavior based on evolution pattern analysis.

In at least one embodiment, the method may include generating one or more nodes using feature extraction from a dataset, wherein each node represents a concept, and determining at least a first relationship among the nodes, wherein the generating is accomplished based on heuristics, for example a heuristic algorithm using the first relationship. The analysis may include the use of heuristics, for example heuristic algorithms, to determine additional relationships, or metadata, among the items in a dataset. Embodiments may also include using the metadata to influence the relative feature extraction.

Still further aspects included for various embodiments are apparent to one skilled in the art based on the study of the following disclosure and the accompanying drawings thereto.

### BRIEF DESCRIPTION OF THE DRAWINGS

The utility, objects, features and advantages of the invention will be readily appreciated and understood from consideration of the following detailed description of the embodiments of this invention, when taken with the accompanying drawings, in which same numbered elements are identical and:

FIG. 1 is a block diagram of a relationship management system according to at least one embodiment;

FIG. 2 is a functional flow diagram illustrating a relationship management method according to an embodiment;

FIG. 3 is a functional block diagram of a computing device according to an embodiment;

FIG. 4 is a detailed flowchart of a relationship management method according to at least one embodiment;

FIG. 5 is an illustration of linkage relationships according to at least one embodiment;

FIG. 6 is a flowchart of an impact method 600 according to at least one embodiment;

FIG. 7 is an example output expertise relationship report according to at least one embodiment;

FIG. 8 is an example specialty structure report according to at least one embodiment;

FIGS. 9a through 9e are example dynamic expertise reports according to at least one embodiment;

FIG. 10 is an example impact evolution pattern report according to at least one embodiment;

FIG. 11 is an example output social relationship report according to at least one embodiment;

FIGS. 12a through 12e are example dynamic social reports according to at least one embodiment;

FIG. 13 is an example dynamic social network report according to at least one embodiment;

FIG. 14 is an example dynamic social network report according to at least one embodiment; and

FIGS. 15a and 15b are example output reports showing correlation statistics according to at least one embodiment.

### DETAILED DESCRIPTION

The present invention is directed generally to data analysis and trend prediction systems and methods. Embodiments may include a data relationship management system and methods having a combined expertise-social network. Embodiments may also include methods and systems for predicting future trends of the expertise-social network as well as a Graphical User Interface (GUI) for outputting a representation of the expertise-social network to a user.

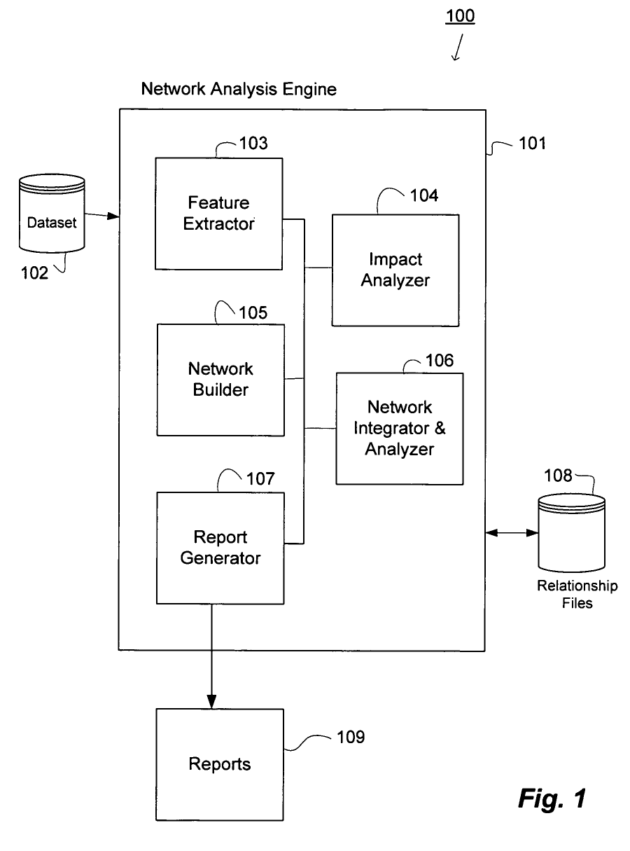

At least one embodiment of a relationship management system 100 according to the present invention may be as shown in FIG. 1. Referring to FIG. 1, the relationship management system 100 may include a network analysis engine 101. The network analysis engine 101 may receive input data from a dataset 102. In at least one embodiment, the dataset 102 may include citation and authorship information for multiple publications; however, the dataset 102 may be any data corpus in which the items thereof include interrelationships. The network analysis engine 101 may include a feature extractor 103, an impact analyzer 104, a network builder 105, a network integrator and data analyzer 106, and a report generator 107. The report generator 107 may output reports 109 to a user as described herein. Further, the report generator 107 may include a GUI.

In at least one embodiment, the feature extractor 103 may receive input information from the dataset 102. The feature extractor 103 may analyze the input data for the presence or absence of one or more characteristics or features deemed to be of interest to the user. In an embodiment, the feature extractor 103 may compile the extracted information of interest that is associated with a particular person or group into a profile for that person or group. The feature extractor 103 may utilize a variety of extraction techniques such as, for example, pattern recognition or image analysis techniques.

The impact analyzer 104 may receive the profile information from the feature extractor 103 and generate an impact ranking for the person or group associated with the profile. In an embodiment, the impact analyzer 104 may generate the impact ranking based on the quantity and quality of the characteristics present in the profile. The impact analyzer 104 may base the impact ranking on a comparison of each profile to a search profile that specifies a set of desired characteristics.

The network builder 105 may generate a representation of the number and quality of instances in which an event involves the person or group being evaluated. In at least one embodiment, the network builder 105 may generate at least two networks for each person or group. First, the network builder 105 may generate an expertise network representing the relative expertise associated with the person or group. Second, the network builder 105 may generate a social network representing the social behavior associated with the person or group. In at least one embodiment, the network builder 105 may generate successive networks for discrete periods time such that the change in the relationships for a person or group may be observed over time, and the furniture state of such relationships predicted for a particular point in the future.

In an embodiment, the network integrator and data analyzer 106 may combine the networks generated by the network builder 105 into a single network. In an embodiment, the network integrator and data analyzer 106 may generate an expertise-social network. The network integrator and data analyzer 106 may perform statistical analyses of the relationships represented by the combined network in order to evaluate each candidate person or group against all others. In at least one embodiment, the network integrator and data analyzer 106 may use heuristics, for example a heuristic algorithm, to determine additional relationships, or metadata, among the items in a dataset. Further, the network integrator and data analyzer 106 may also include using the metadata to influence the feature extraction such as, for example, the impact profile determined by the impact analyzer 104.

In an embodiment, the report generator 107 may output to a user one or more reports depicting the relationships and their statistical properties in order to allow a user to evaluate each person or group being analyzed relative to all other persons/groups of interest.

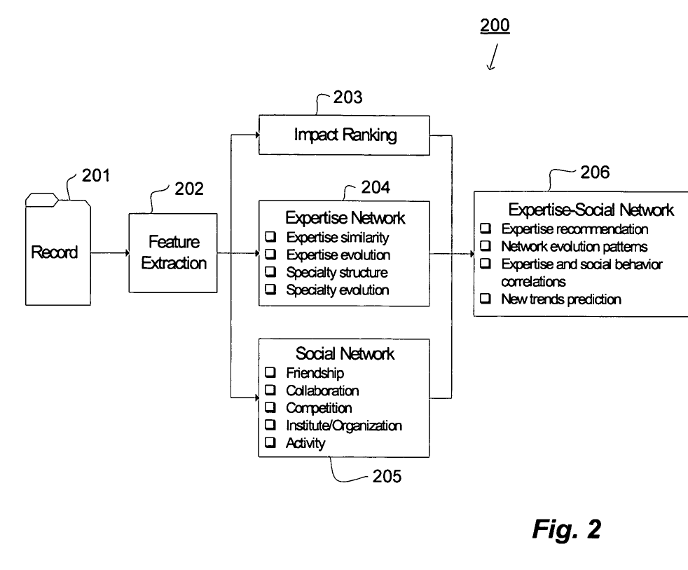

FIG. 2 is a functional flow diagram illustrating the overall process of determining an expertise-social network. Referring to FIG. 2, a relationship management method 200 according to at least one embodiment may include the following steps. First, the method 200 may include extracting features at 202 from a record 201 (from, for example, the dataset 102) for further analysis. In at least one embodiment, for example, the features extracted from records 201 may include relational evidences or attributes among experts as set forth in more detail herein below.

Following feature extraction, the method 200 may then perform impact ranking at 203. In an embodiment, impact ranking 203 may include analyzing the impact of a particular person or group such as, for example, an expert in a particular technical field. The method 200 may determine a ranked list of such experts based on their impact. Impact may be defined as a numeric value that is determined as a result of one or more statistical methods or algorithms as described herein. In an embodiment, the impact provides the user with the capability to evaluate individuals or groups using both quantitative and qualitative factors.

The method 200 may also include building an expertise network at 204. The expertise network 204 may provide a representation of the kind of expertise possessed by a given individual or group. In an embodiment, the expertise network 204 may be used to identify a measure of the expertise possessed by an expert. Further, in at least one embodiment, the expertise network 204 may provide to the user an indication of how multiple experts are interconnected among one another based on the expertise relationships present over time. The expertise network 204 may also explain how such experts relate to each other and how these relationships develop over time as shown in further detail herein. For example, the expertise network 204 may identify relationships such as, but not limited to, expertise similarity, expertise evolution, specialty structure, and specialty evolution among experts.

The method 200 may also include building a social network at 205. The social network 205 may provide a representation of who knows whom among a set of individuals or groups such as, for example, the experts associated with a particular technical field. In at least one embodiment, the social network 205 may identify relationships such as, but not limited to, friendship, collaboration, competition, organization relationship, and past activities among experts.

The method 200 may also include forming an expertise-social network at 206. In at least one embodiment, the expertise-social network 206 may include the representation of a combination of some or all of the relationships maintained by the expertise network 204 and the social network 205. The expertise-social network 206 may provide an integrated user profile for all individuals or groups under consideration and provide for an expert recommendation to a user. Further, in at least one embodiment, the method 200 may include conducting network analysis on the expertise-social network 206 through the application of statistical methods to the relationships identified therein. For example, the method 200 may thereby provide the user with reports documenting the results of the statistical analyses such as, but not limited to, detecting expertise and social network evolution patterns, correlating expertise behavior and social behavior, and predicting new trends for the whole community or for an individual's future behavior, as described herein.

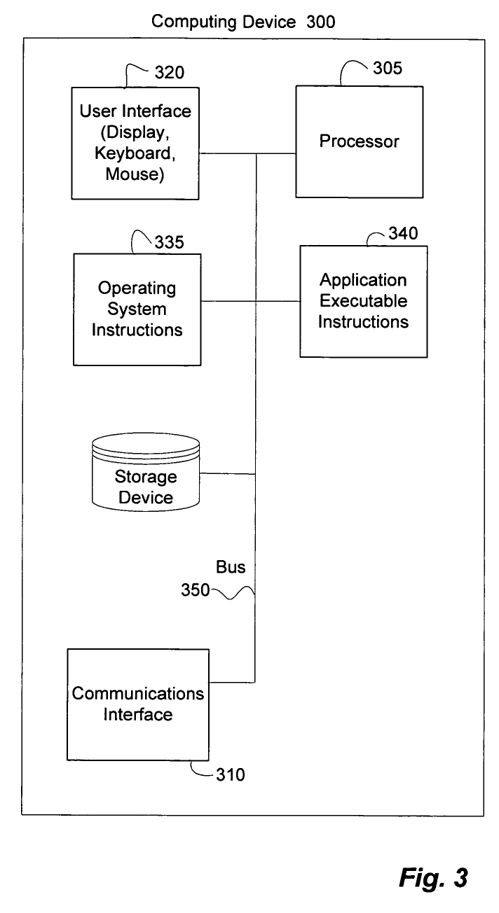

In at least one embodiment, the network analysis engine 101 may be implemented using a computing device such as, for example, a personal computer, programmed to execute a sequence of instructions that configure the computer to perform operations as described herein. In an embodiment, the computing device may be a personal computer available from any number of commercial manufacturers such as, for example, Dell Computer of Austin, Tex., running the Windows™ XP™ operating system, and having a standard set of peripheral devices (e.g., keyboard, mouse, display, printer). FIG. 3 is a functional block diagram of one embodiment of a computing device 300 that may be useful for hosting software application programs implementing the network analysis engine 101. Referring now to FIG. 3, the computing device 300 may include a processor 305, a communications interface 310, a user interface 320, operating system instructions 335, application executable instructions/API 340, all provided in functional communication using a data bus 350. The processor 305 may be any microprocessor or microcontroller configured to execute software instructions implementing the functions described herein. Application executable instructions/APIs 340 and operating system instructions 335 may be stored using computing device 300 nonvolatile memory. Application executable instructions/APIs 340 may include software application programs implementing the network analysis engine 101. Operating system instructions 335 may include software instructions operable to control basic operation and control of the processor 305. In one embodiment, operating system instructions 335 may include the XP™ operating system available from Microsoft Corporation of Redmond, Wash.

Instructions may be read into a main memory from another computer-readable medium, such as a storage device. The term “computer-readable medium” as used herein may refer to any medium that participates in providing instructions to the processor 305 for execution. Such a medium may take many forms, including, but not limited to, non-volatile media, volatile media, and transmission media. Non-volatile media may include, for example, optical or magnetic disks or storage devices. Volatile media may include dynamic memory such as a main memory. Transmission media may include coaxial cable, copper wire, and fiber optics, including the wires that comprise the bus 350. Transmission media may also take the form of acoustic or light waves, such as those generated during Radio Frequency (RF) and Infrared (IR) data communications. Common forms of computer-readable media include, for example, floppy disk, a flexible disk, hard disk, magnetic tape, any other magnetic medium, Universal Serial Bus (USB) memory stick™, a CD-ROM, DVD, any other optical medium, a RAM, a ROM, a PROM, an EPROM, a Flash EPROM, any other memory chip or cartridge, a carrier wave as described hereinafter, or any other medium from which a computer can read.

Various forms of computer-readable media may be involved in carrying one or more sequences of one or more instructions to the processor 305 for execution. For example, the instructions may be initially borne on a magnetic disk of a remote computer. The remote computer may load the instructions into its dynamic memory and send the instructions over a telephone line using a modem, which may be an analog or digital or DSL modem. The computing device 300 may send messages and receive data, including program code(s), through a network via the communications interface 310. A server may transmit a requested code for an application program through the Internet for a downloaded application. The received code may be executed by the processor 305 as it is received, and/or stored in a storage device or other non-volatile storage for later execution. In this manner, the computing device 300 may obtain an application code in the form of a carrier wave.

The network analysis engine 101 may reside on a single computing device or platform 300, or on more than one computing device 300, or different applications may reside on separate computing devices 300. Application executable instructions/APIs 340 and operating system instructions 335 may be loaded into one or more allocated code segments of computing device 300 volatile memory for runtime execution. In one embodiment, computing device 300 may include 512 MB of volatile memory and 80 GB of nonvolatile memory storage. In at least one embodiment, software portions of the network analysis engine 101 may be implemented using C programming language source code instructions. Other embodiments are possible.

Application executable instructions/APIs 340 may include one or more application program interfaces (APIs). The network analysis engine 101 application programs may use APIs for inter-process communication and to request and return inter-application function calls. For example, an API may be provided in conjunction with a database in order to facilitate the development of SQL scripts useful to cause the database to perform particular data storage or retrieval operations in accordance with the instructions specified in the script(s). In general, APIs may be used to facilitate development of application programs which are programmed to accomplish the functions described herein.

The communications interface 310 may provide the computing device 300 the capability to transmit and receive information over the Internet, including but not limited to electronic mail, HTML or XML pages, and file transfer capabilities. To this end, the communications interface 310 may further include a web browser such as, but not limited to, Microsoft Internet Explorer™ provided by Microsoft Corporation. The user interface 320 may include a computer terminal display, keyboard, and mouse device. One or more Graphical User Interfaces (GUIs) also may be included to provide for display and manipulation of data contained in interactive HTML or XML pages.

The network analysis engine 101 may maintain relationship information using relationship files 108. In an embodiment, the relationship files 108 may be maintained according to the multiple desired characteristic for a particular candidate, in which each object in the relationship files may include fields for object identity and object profiles including impact profile, expertise profile, and sociability profile.

The Identity field may specify the identity information of the object, including name (string), gender (string), institution (string) and etc. The Impact profile may be a three-dimensional schema in which the first dimension is a vector defining a set of desired expertise, and the second dimension is a real valued vector denoting the impact of each desired expertise for this particular object, and the third dimension is time period of the profile. The Expertise profile may be a three-dimensional schema in which the first dimension is a vector defining a set of desired expertise, and the second dimension is a real valued vector denoting the contribution of each desired expertise for this particular object, and the third dimension is time period of the profile. The Sociability profile may be a three-dimensional schema in which the first dimension is a vector defining a set of desired connection, and the second dimension is an integer valued vector denoting the number of each desired social connection for this particular object, and the third dimension is time period of the profile.

The Time period of the profile may be a two-dimensional schema in which the first dimension is “starting_time (dd-mm-yy)” and the other is “ending_time (dd-mm-yy).”

In an embodiment, the network analysis engine 101 may also include a Database Management System (DBMS) for maintaining the relationship files 108. The DBMS may be, for example, a software application such as SQL Server 7.0 provided by Microsoft Corporation of Redmond, Wash., or similar products provided by Oracle® Corporation of Redwood Shores, Calif., for storage and retrieval of, for example, relationship data in accordance with the Structured Query Language (SQL) database format. Alternatively, the relationship files 108 may be implemented using an open source DBMS such as PostgreSQL™.

In an embodiment, the network analysis engine 101 may execute a sequence of SQL scripts operative to store or retrieve particular items arranged and formatted in accordance with a set of formatting instructions. For instance, the network analysis engine 101 may execute one or more SQL scripts in response to a request from the user to generate a report depicting particular relationship information in a format suitable for display to the user using a display. In an embodiment, the network analysis engine 101 may output the report to the user using a web browser software application such as, for example, Internet Explorer™ provided by Microsoft Corporation.

Further, the network analysis engine 101 may be configured to generate and transmit interactive HTML or XML pages to user terminals via a network. In particular, the network analysis engine 101 may receive requests for information as well as user entered data from a user terminal. Such user provided requests and data may be received in the form of user entered data contained in an interactive HTML or XML page provided in accordance with, for example, the Java Server Pages™ standard developed by Sun™ Microsystems. Alternatively, user provided requests and data may be received in the form of user entered data contained in an interactive HTML or XML page provided in accordance with the Active Server Pages (ASP) standard. In response to a user entered request, the network analysis engine 101 may generate a report in the form of an interactive HTML or XML page by obtaining expertise or social information corresponding to the user request by transmitting a corresponding command to a database requesting retrieval of the associated data. The database may then execute one or more scripts to obtain the desired information and provide the retrieved data to the network analysis engine 101. Upon receipt of the requested data, the network analysis engine 101 may build an interactive HTML or XML page including the requested data and transmit the page to the requestor in accordance with, for example, HTML and Java Server Pages™ (JSP) formatting standards.

In at least one embodiment, users may interact with the network analysis engine 101 via a network such as, but not limited to, the Web. To access the network analysis engine 101, in an embodiment, a user may enter the URL associated with network analysis engine 101 into the address line of a Web browser application of Web-enabled terminal or device such as a PC, Personal Digital Assistant (PDA), Internet-enabled cellular or mobile phone, and the like. Alternatively, a user may select an associated hyperlink contained on an interactive page using a pointing device such as a mouse or via keyboard commands. This causes an HTTP-formatted electronic message to be transmitted to the network analysis engine 101 (after Internet domain name translation to the proper IP address by an Internet proxy server) requesting a HTML or XML page. In response, the network analysis engine 101 generates and transmits a corresponding interactive HTTP-formatted HTML or XML page to the requesting terminal, and establishes a session. The HTML or XML page may include data entry fields in which a user may enter information such as the client's identification information, contact information, etc. The user may enter the prompted information into the appropriate data entry fields of the HTML or XML page and cause the terminal to transmit the entered information via interactive HTML or XML page to the network analysis engine 101. In response to receiving the user transmitted page populated with user provided information, the network analysis engine 101 may validate the received information by comparing the information received to corresponding stored data. This validation may be requested by the network analysis engine 101 to be performed by a database server by executing one or more validation scripts. If the database server determines that the information is valid, or in response to an entry request, then the network analysis engine 101 may generate and transmit a report page to a terminal. In this way, page content for pages provided by the network analysis engine 101 may be dynamic, while page frames may be statically defined. The dynamic and static information may be included in a database.

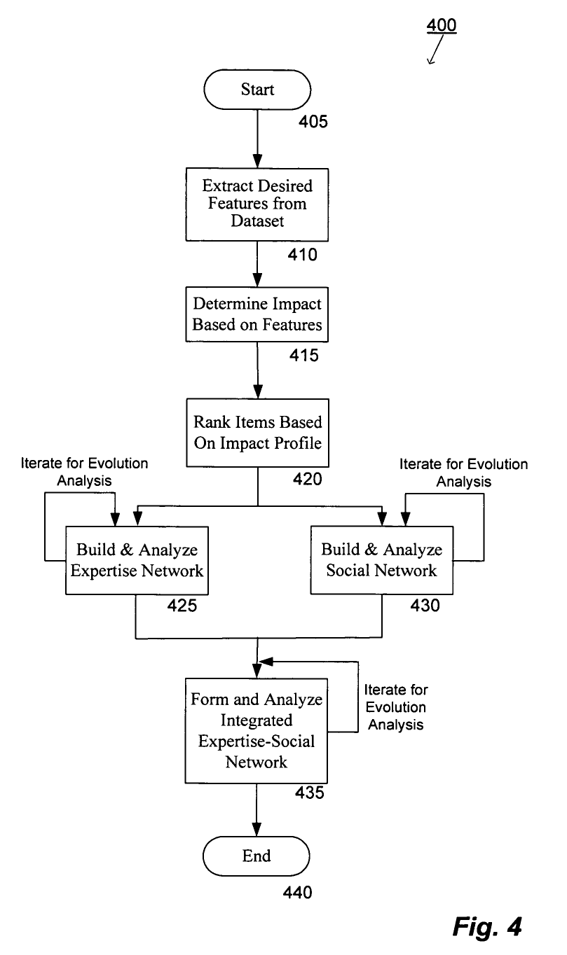

For illustrative purposes, an exemplary embodiment of the relationship management system and method will now be described. FIG. 4 is a detailed flowchart of a method 400 according to at least one embodiment that may be used to assist a user in determining and analyzing an expertise-social network for one or more experts such as, for example, authors of technical publications. For example, the inventors have applied the method 400 to provide an expertise management system for authors in database community for, among other things, ranking authors according to their impacts in the database community, measuring their expertise similarity, identifying their social relationship and making recommendations for expertise queries. Other embodiments are possible.

The method 400 may be applied to any dataset that evaluates objects and identifies the relationships between objects. Examples of such datasets include, but are not limited to, publication datasets for selecting experts in questions and reviews referral, business records for evaluating employees or recruiting interviewers, and Web logs or blogs for identifying influencers and their relationship. (A Web log or blog may be a sequence of electronic mail messages concerning a particular topic.) For example, the method 400 may be applied to a dataset that includes publication objects in the computer science and database community and that specifies relationships among the objects. In an embodiment, the inventors have applied the method 400 to a dataset that includes a subset of conference publications collected from DBLP available on the Web at www.dblp.uni-trier.de/. Selecting publications of four major conferences occurring in the database community over twenty-five years, including American Society of Computing Machinery (ACM) SIGMOD (Special Interest Group on Management of Data), VLDB (International Conference on Very Large Databases), PODS (Principles of Database Systems), and ICDE (International Conference on Data Engineering) yields 5813 publications and 5807 authors in this dataset.

Referring to FIG. 4, a method 400 may commence at 405. Control may then proceed to 410, at which a method may include extracting features for a concept from relationships or linkages identified within a dataset. In an embodiment, the concepts extracted from the dataset may be represented by nodes. Control may then proceed to 415, at which the impact may be determined based on the extracted features. Control may then proceed to 420, at which the items, or nodes, obtained from the dataset may be ranked or relatively evaluated based on the impact profile. Control may then proceed to 425 and 430, at which an expertise network and a social network, respectively, may be built and analyzed. Control may then proceed to 435, at which an integrated expertise-social network may be formed and analyzed. Control may then proceed to 437, at which the method may include outputting a report representing the contents of the impact profile, the expertise profile, and the social profile. The report may further indicate a relative ranking, correlation, and/or evolutionary trend based on the contents of the impact profile, the expertise profile, and the social profile. Control may proceed to 440, at which a method may end. Further details regarding the at least one embodiment shown in FIG. 4 follow.

Regarding 410, in an embodiment, the feature extractor 103 may be configured to perform feature extraction using heuristics, for example a heuristic algorithm, based on at least one relationship among the items in the dataset. In at least one embodiment, for an exemplary dataset that includes authors' relationships with respect to publications in a technical field, linkage relationships for which features are extracted may include:

Citation links: A citation link may identify an instance in which a particular expert (e.g., author) is cited in a publication within a technical field. The more frequently authors are cited by high quality publications, the more impact the author has in the research community.

Co-author links: A co-author link may identify an instance in which a particular expert (e.g., author) co-authors a technical publication. The more frequently an expert appears as a co-author, the stronger collaboration relationship associated with the expert.

Co-citation links: A co-citation link may identify instances in which an expert (e.g., author) is cited along with other authors. The more frequently authors are cited together, the stronger the associated expertise relationship.

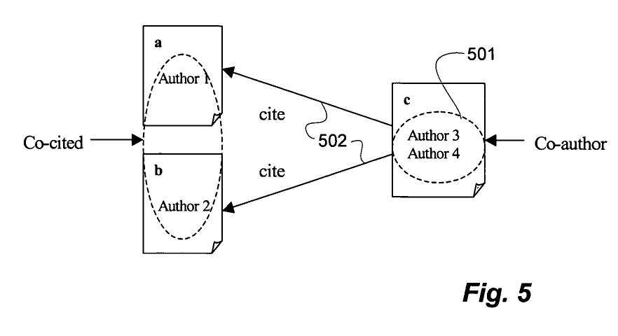

FIG. 5 is an illustration of these linkage relationships for three publications. Referring to FIG. 5, Author 1 is the author of paper ‘a,’ Author 2 is the author of paper ‘b,’ and Author 3 and Author 4 are the co-authors of paper ‘c.’ If paper ‘c’ cites paper ‘a’ and paper ‘b,’ authors 3 and 4 form co-author relationship, or co-author link 501, and authors 1 and 2 form co-citation relationship, or co-citation link 502. Other relationships may be identified similarly using other linkage relationships. The extracted features or linkage information may be stored in non-volatile memory, such as the relationship files 108, for later use in analysis.

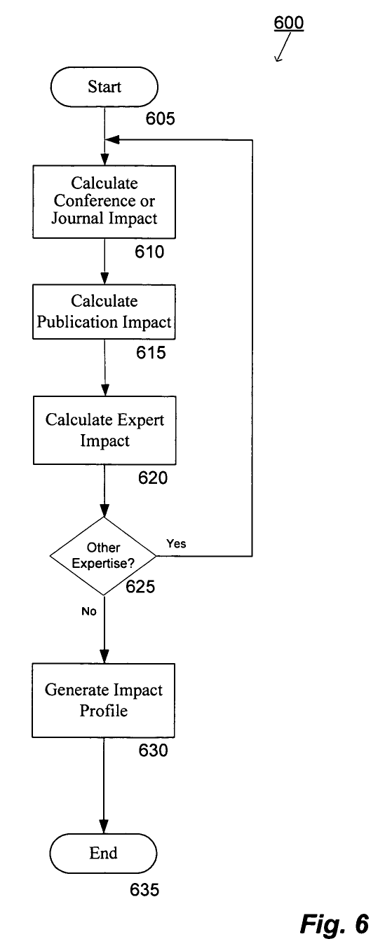

Returning to FIG. 4, control may then proceed to 415 to determine the expert impact. At 415, in at least one embodiment the method may determine the impact associated with a particular item in the dataset (for example, a particular expert) by analyzing the features or linkage relationships extracted at 410. In at least one embodiment, the method may use heuristics, for example an impact rank heuristic algorithm, to evaluate the impact of the items or experts based on citation numbers and the quality of publications citing the expert. For example, the more frequently authors are cited by quality publications, the more impact they tend to have in the whole research community of interest. In at least one embodiment, the impact rank method or heuristic algorithm may include three steps as follows: calculating the impact of a conference/journal, calculating the impact of a publication, and calculating the impact of the experts being evaluated. An example method or heuristic for determining the impact at 415 of an item in the dataset may be described with respect to FIG. 6.

FIG. 6 is a flowchart of an impact heuristic algorithm or method 600 according to at least one embodiment. Referring to FIG. 6, the method may commence at 605. Control may then proceed to 610, at which the method may calculate the impact of a conference or journal. The conference impact in which a paper is published may be considered as pre-knowledge of the publication's impact. In at least one embodiment, the impact of a conference or journal may be measured by the citation ratio of the publication in that conference or journal calculated as the number of citations for all publications of the conference divided by the number of publications for the conference, as shown in Equation (1) below. Conferences or journals with high impact tend to have higher average citation ratios.

$$R ( C ) = \frac{\# citations}{\# publications} \qquad Eq . ( 1 )$$

where C is an ordinal number representing a particular conference, and R is the citation ratio for a particular conference, C.

Control may then proceed to 615, at which the method may calculate the impact of a publication. In an embodiment, the quality of publications may be calculated by considering two factors: one is the conference impact this publication published in; the other is the publication impact of the paper citing it. The higher the impact of a conference/journal paper P that is published and the higher the impact of publications the paper P gets cited from, the higher impact of P is. This calculation is shown below in Equation (2).

$$R ( P ) = ( 1 - d ) \cdot R ( C ) + d \cdot {\sum }_{j = 1}^{cited\_num} \frac{R ( {P}_{j} )}{N ( {P}_{j} )} \qquad Eq . ( 2 )$$

where R(C) is the impact of the conference where publication P is published in, Cited_num is the total number of publications citing P, R(Pⱼ) is the publication impact of publication Pⱼ which cites publication P, and N(Pⱼ) is the number of publication cited by publication Pⱼ. d is a parameter to control the balance between the influence from the impact of the conference this publication published in and that from the impact of the paper citing it. This is an iterative procedure.

Control may then proceed to 620, at which the method may calculate the impact of an expert. In an embodiment, the impact of an expert may be calculated based on citation numbers and the quality of publications citing the expert as shown in Equation (3) below. The more frequently an expert is cited by other experts' or authors' quality publications, the more impact the expert tends to have in the research community of interest.

$$R ( A ) = {\sum }_{k = 1}^{pub\_num} ( {\sum }_{j = 1}^{{cited\_num}_{k}} R ( {P}_{j}^{k} ) ) . \qquad Eq . ( 3 )$$

where pub_num is the total number of publication author A has published, cited_numₖ is the total number of publications citing author A's k^{th} publication and R(P^{k}ⱼ) is the impact of the publication Pⱼ^{k} which has cited author A's k^{th} publication.

Control may then proceed to 625, at which the method may repeat 610 through 620 for another type of expertise (e.g., expertise in a different or related technical field). If no further calculations are desired, control may proceed to 630. At 630, the method may generate an impact profile for an expert representing the expert impact for each type of expertise evaluated. In at least one embodiment, the impact profile may be represented as a vector R=<(e₁, e₂ . . . , eₙ), (r₁, r₂, . . . , rₙ), T>, in which (e₁, e₂ . . . , eₙ) is a set of expertise, each rᵢ as the impact score of the expertise eᵢ and T as the time period of the profile. The impact of a publication or an author is a “vote” from all the other publications, and may act as a reference as to how important a publication or an author is. A citation to a publication or an author counts as a vote of support. The impact of a person may also be time-dependent. Also, the factor of which level's conference the paper is published in may also be taken into consideration.

Control may then proceed to 635, at which an expert impact determination method may end. Thus, for each type of expertise, the method allows a user to calculate the impact of an expert (such as, for example, an author) and to represent this information in a manner that allows for ranking of experts according to different types of expertise. Further information regarding impact determination is described in commonly assigned U.S. Patent Application No. ______, Attorney Docket No. 4022 (NECLAB-PAUS0003), filed ______, the entire disclosure of which is hereby incorporated by reference as if set forth fully herein. In particular, FIGS. 3 through 5 and the description related thereto contained in U.S. Patent Application ______, Attorney Docket No. 4022 (NECLAB-PAUS0003), illustrate a method of representing concepts extracted from a dataset as multiple linked nodes. By accounting for social networking relationships among the nodes that represent, for example, different individuals, in the analysis and evaluation of features extracted for items in the dataset (such as, for example, the relative expertise of individuals), then at least one embodiment may advantageously provide the user with a stronger prediction of the relative ranking of the items (e.g., experts) by analyzing the combined first relationship (e.g., expertise) and a second relationship (e.g., social networking) in combination.

Returning to FIG. 4, upon determining the expert impact at 415, control may proceed to 420, at which the method may rank the items (e.g., experts) according to the impact profile (reference FIG. 6) for each expert being evaluated for a particular type of expertise. In at least one embodiment, experts may be ranked according to the cumulative impact score represented in the impact profile R.

Alternatively, the method may produce the ranked list of experts using another ranking method or algorithm. For example, the PageRank method or algorithm may be used. PageRank is a Web page ranking algorithm developed by Google, Inc. Details of the PageRank algorithm are described in Brin et al., “The Anatomy of a Large-Scale Hypertextual Search Engine,” 30 Computer Networks and ISDN Systems, pp. 107-117, 1998. In the PageRank algorithm, the importance of a Web page is decided by the support from all the other pages on the Web. A link to a page counts as a vote of support. The procedure of PageRank to rank the impact of authors can be defined as follows: Assume author A has a group of authors A₁ . . . Aₙ pointing to him (i.e., are citations). The parameter d is a damping factor, which is usually set to 0.85. N(Aᵢ) is defined as the number of outgoing links (citations) from author Aᵢ. The PageRank of an author A, denoted PR(A), is thus given as follows by Equation (4):
PR(A)=(1−d)+d(PR(A₁)/N(A₁)+ . . . +PR(Aₙ)/N(Aₙ)) Eq. (4)

However, using Equation (4) to calculate the impact of an expert has limitations. First, PageRank cannot differentiate the contribution from different publication citations. Therefore, if author A was cited by an influential paper of Aᵢ, he should get more credit comparing to the citation from a poor quality paper of Aᵢ. However, Equation (4) treats all the citations from author Aᵢ to author A as the same weight. Furthermore, Equation (4) cannot consider the initial impact of an object. The impact of an object is solely dependent on other objects citing him as shown in Equation (4). Thus, pre-knowledge of an object's impact is not taken into account, which can lead to less accurate analysis. For example, a paper published in a very good conference tends to have better quality than the paper published in a lower-level conference, although they might have equal number of citations.

In an embodiment, the impact analyzer 104 may be configured to determine expert impact as described at 415, 420, and FIG. 6.

Control may then proceed to 425, at which the method may include building and analyzing an expertise network such as the expertise network 204. Building the expertise network at 425 and building the social network at 430 may be accomplished in any order or at the same time. In an embodiment, the network builder 105 may be configured to build the expertise network and social network as described at 425 and 430, respectively. In at least one embodiment, the expertise network of publication dataset may be created based on a first relationship coefficient such as, for example, the co-citation linkage information of authors as described previously. In constructing the expertise network, an author may be considered as another author's neighbor if they have been co-cited by one or more paper. Thus, the more times authors are cited together, the stronger expertise similarity they have in the eyes of citers. Time stamps may be attached to each of the co-citation links. The expertise network may be used to identify the expertise of experts and to provide a report to the user illustrating how experts connect with each other based on their expertise relationship over time.

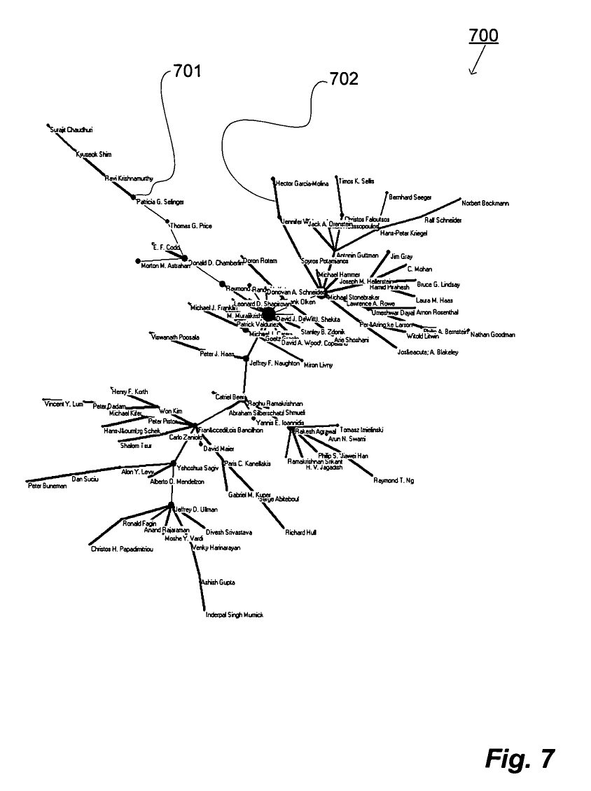

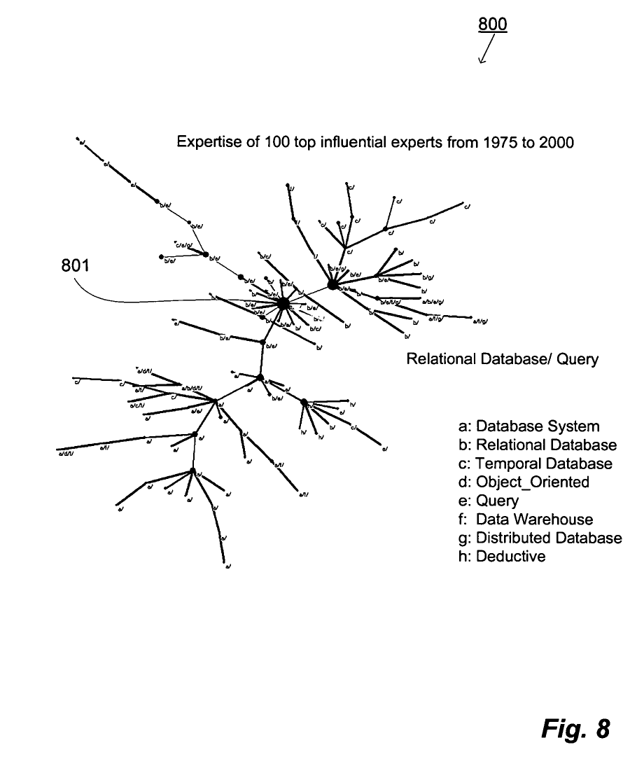

FIG. 7 is an example output expertise relationship report 700 according to at least one embodiment showing an expertise network for one hundred top influential experts from 1975 to 2000. Each node 701 in FIG. 7 represents an author, and the node size is proportional to the impact of this person in the technical field of interest over a time span of twenty-five years. Each link 702 may represent an expertise similarity and link thickness is proportional to the similarity degree. Similarity degree may be a weight assigned to a link indicating the relative similarity between the technical field of a publication and a reference technical field of interest. Observing FIG. 7, the dataset features in this example form a well-connected specialty structure (where a specialty is expertise in a particular technical field). The expertise network may be used to reveal major specialties in a research community, explain how these specialties relate to each other and identify the contribution of experts to each specialty. In addition, statistical methods such as factor analysis may be applied to the co-citation linkage information, for example, from 1975 to 2000, to discover relationships among dependent variables associated with the information represented. Further details regarding factor analysis are described in Spearman, “General Intelligence, Objectively Determined and Measured,” 15 American Journal of Psychology, pp. 201-293, 1904. In an embodiment, the co-citation linkage information may be maintained or stored as a co-citation matrix with each variable representing one particular specialty or expertise. Certain of the factors may be output using a specialty structure report 800 as shown in FIG. 8. Referring to the example shown in FIG. 8, the eight largest factors have been identified as major specialties in the database community during this time period. The factor loadings of each author are treated as an expertise profile, which may be expressed in the form of E=<(e₁, e₂ . . . , eₙ), (v₁, v₂, . . . , vₙ), T>, in which (e₁, e₂ . . . , eₙ) is a set of expertise, each vᵢ as the factor loading of the i^{th} expertise eᵢ and T as the time period of the profile. For example, FIG. 8 shows the expertise contribution of one hundred top influential experts from 1975 to 2000 using the expertise profile. In an embodiment, an expert whose cumulative expertise profile for a particular expertise exceeds a pre-defined threshold value may be designated as a contributor to the corresponding expertise. For example, authors whose eᵢ in their expertise vectors are higher than the threshold value 0.30 may be designated as contributors to the i^{th} specialty and represented as such in FIG. 8. From the expertise network in FIG. 8, a user may thus observe not only the connection between experts based on expertise similarity, but also the relationships among different specialties. For example, many people possessing expertise in a particular technical field such as relational databases are also shown as tending to possess expertise in related technical fields such as “query” expertise 801 as shown in FIG. 8. In the “query” expertise 801 example in FIG. 8, the user may determine that people who have the expertise in the “Relational Database” field also tend to have the “query” expertise.

The relationships among different specialties is useful for an expertise search application, especially when there is not an exact match of certain expertise, in which case a user may find candidates with related expertise.

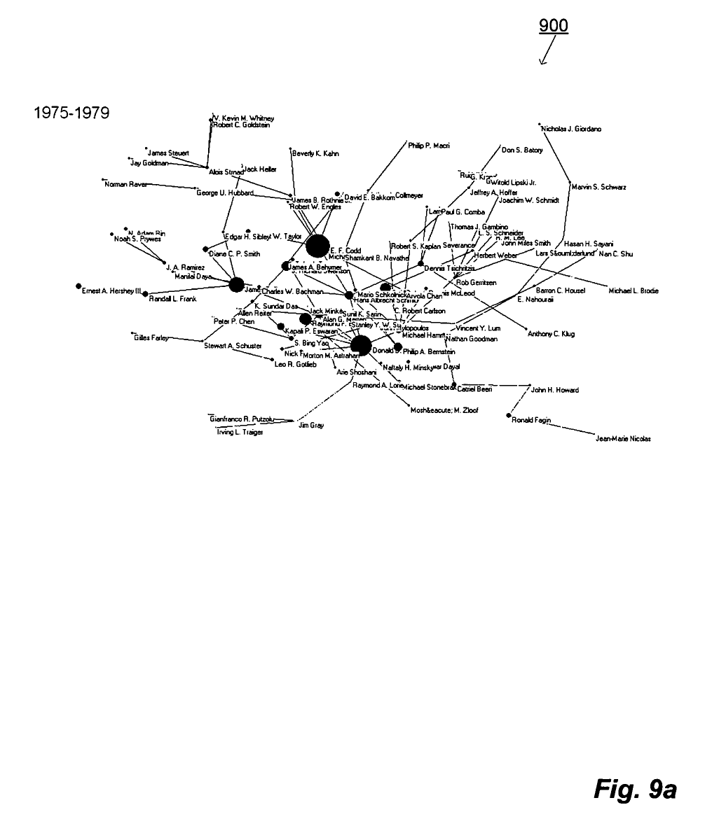

Furthermore, embodiments may allow a user to observe the evolution of the expertise network over time. In this regard, in addition to studying the static network properties over a single twenty-five year period, the dynamic features of expertise networks may be observed over successive discrete periods of time. For example, the dataset spanning a twenty-five year period as described above may also be viewed as five successive five-year time segments. FIGS. 9a through 9e are example dynamic expertise reports 900 from which a user may observe the top one hundred influential people for the expertise under consideration for each of the discrete time periods. In an embodiment, the dynamic expertise reports 900 may be output to the user via a Graphical User Interface (GUI) using, for example, a computer display. By thus providing the user with an indication of how the expertise network changes over time, embodiments may output to the user an indication of the expertise network evolution. Referring to FIGS. 9a-9e, embodiments may also provide an indication of expertise increasing for an expert over time as well as decreasing expertise over time. For example, in at least one embodiment, darkened nodes 901 may be used to represent increasing expertise while lighter-colored nodes 902 may be used to represent decreasing expertise. Other representation schemes are possible. For example, in at least one embodiment, red nodes may be used to represent experts emerging in current time segment, white nodes used to represent experts disappearing from previous time segment, and blue nodes used to represent experts existing in both previous and current time segment. Alternatively, different symbols may be used to represent nodes having different properties. Links 903 may represent the expertise relationship between experts. In an embodiment, the color or grayscale differences of links may have the same meaning as the color of the nodes.

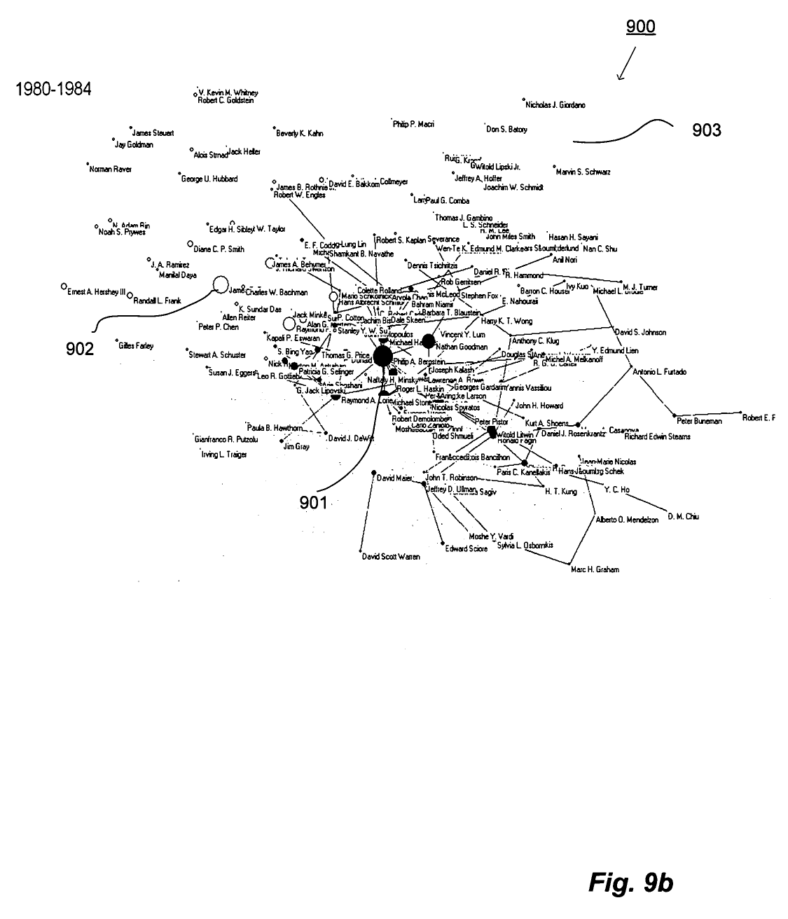

By using these representation schemes, embodiments may provide the capability for a user to identify various aspects of the experts' relationships with respect to time. For example, the network builder may also be configured to build expertise networks to indicate specialized relationship queries such as, for example, the impact evolution pattern of all the authors who have appeared in at least one of the time segment. FIG. 10 is an example impact evolution pattern report 1000 according to at least one embodiment. Referring to FIG. 10, the impact evolution pattern report 1000 may provide an indication of the distribution of authors in each impact evolution pattern. As shown in FIG. 10, approximately 22% of authors had their expertise always down or decreasing over time, while 20% of the authors had expertise always up or increasing over time, and so on. The inventors have found that very few experts can increase individual impact after the impact drops. The possible reasons of dropping impact include, but are not limited to: 1) this person retired from the research community, or 2) the topic he works on is out-of-date. Embodiments may thereby provide another tool useful for evaluating the expertise of a person or group over time.

Furthermore, factor analysis may be applied to the expertise network structure for each time segment (reference FIGS. 9a-9e) to automatically detect an expertise network evolutionary point. An evolutionary point may be a point in time at which a significant change occurs in the expertise network structure. Such evolutionary points may be useful to allow a user to investigate fundamental changes occurring in the field of interest. For example, for the example dataset for the period 1975 to 2000 described above, the expertise network structure in the database community changed dramatically in 1985 and 1995. Reasons for these changes may include, for example, that after 1985, object oriented databases became popular. Similarly, after 1995, data mining, Web-based databases, and data warehousing became popular. Therefore, if many years later (in 2004, for example), a person still works in an aging technology such as deductive databases, the chance of getting a citation is very low. Evolutionary points may thus provide another useful tool for evaluating the expertise of a person or group over time.

Returning to FIG. 4, at 430 the method may include building and analyzing a social network such as the social network 205. In at least one embodiment, the expertise network of publication dataset may be created based on a second relationship coefficient such as, for example, the co-author linkage information as described previously. In constructing the social network, an author may be considered as another author's neighbor if they have co-authored one or more papers. Thus, the more times authors are co-author papers, the stronger collaboration relationship they have. Time stamps may be attached to each of the co-author links. In an embodiment, the social network may be used to identify social relationships between or among experts and to provide a report to the user illustrating how experts connect with each other based on their social relationship over time. Social relationships captured by the social network may include, but are not limited to, collaboration, friendship, competition, organizational relationship and past activities. For this dataset, we may create a social network only based on the collaboration relationship, which is derived from co-author information.

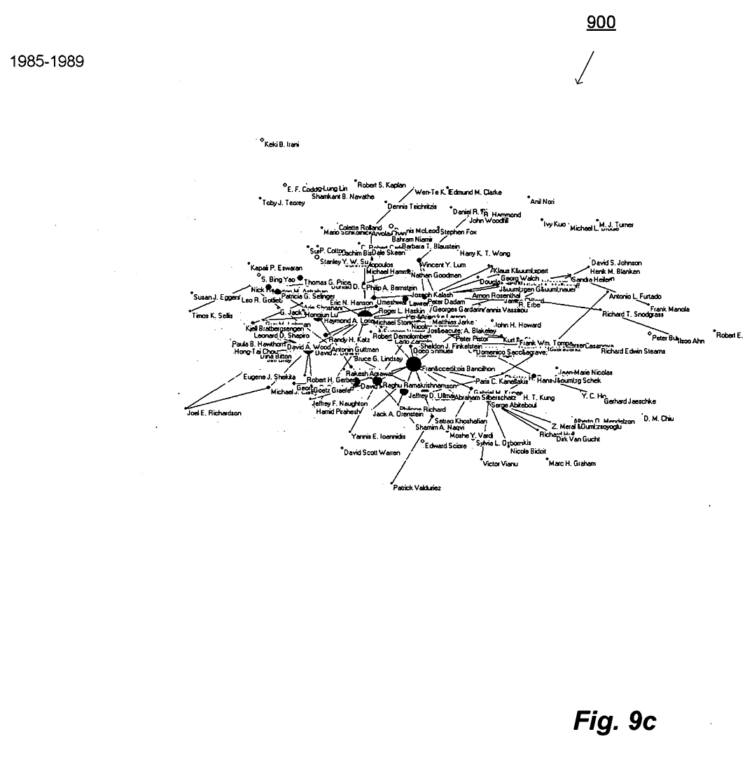

FIG. 11 is an example output social relationship report 1100 showing an expertise network for one hundred top influential experts from 1975 to 2000. As in FIG. 7, each node 1101 in FIG. 11 may represent an author, and the node size is proportional to the impact of this person in the technical field of interest over a time span of twenty-five years. Each link 1102 may represent a collaboration link and thickness is proportional to the degree of collaboration. Observing FIG. 11, the dataset features in this example form a well-connected social structure. The social network may thus be used to reveal social relationships among experts.

In addition, statistical methods such as factor analysis may be applied to the co-authorship linkage information, for example, from 1975 to 2000, to discover relationships among dependent variables associated with the information represented. Further details regarding factor analysis are described in Spearman, “General Intelligence, Objectively Determined and Measured,” 15 American Journal of Psychology, pp. 201-293, 1904. In an embodiment, the co-authorship linkage information may be maintained or stored as a co-authorship matrix with each variable representing a co-authorship link. In at least one embodiment, the co-authorship links for each author may be maintained using a sociability profile represented as a list S=<(o₁, o₂ . . . , oₘ), (n₁, n₂, . . . , nₘ), T>, in which (o₁, o₂ . . . , oₘ) is a set of collaboration candidates, each nᵢ as the collaboration number with the i^{th} candidate oᵢ and T as the time period of the profile. This representation facilitates statistical analysis of the social relationships according to various criteria.

For example, in at least one embodiment, statistics determined for social relationships may include the following. Each of these statistics may be determined for each five-year time segment of the twenty-five year period for the example dataset, for which is created a social network for all the authors who have published at least one paper in a given period. Social network statistics may include a collaboration range based on, for example: 1) The number of authors per paper; 2) the average degree, representing the average number of co-authors per author occurrence; and 3) the relative size of the largest cluster, defined as the ratio of the size of the largest connected community to the size of the whole community.

The social network statistics may further include the connection ties within communities based on, for example: 1) Clustering coefficient of a node v, given by:

$$c ( v ) = \frac{2 * Neighbor\_links ( v )}{degree ( v ) * ( degree ( v ) - 1 )} \qquad Eq . ( 5 )$$

where Neighbor_links(v) is the number of links among all the neighbors of node v. It reflects the probability of that a node's collaborators collaborate with each other.

The connection ties statistics may further include: 2) Clustering coefficient of a network G, given by:

$$c ( G ) = \frac{\sum c ( v )}{\vert v \vert} \qquad Eq . ( 6 )$$

where |v| is the total number of nodes in G.

In addition, the connection ties statistics may further include: 3) Connections ties across communities expressed in terms of the average separation or average shortest distances between every pair of reachable nodes.

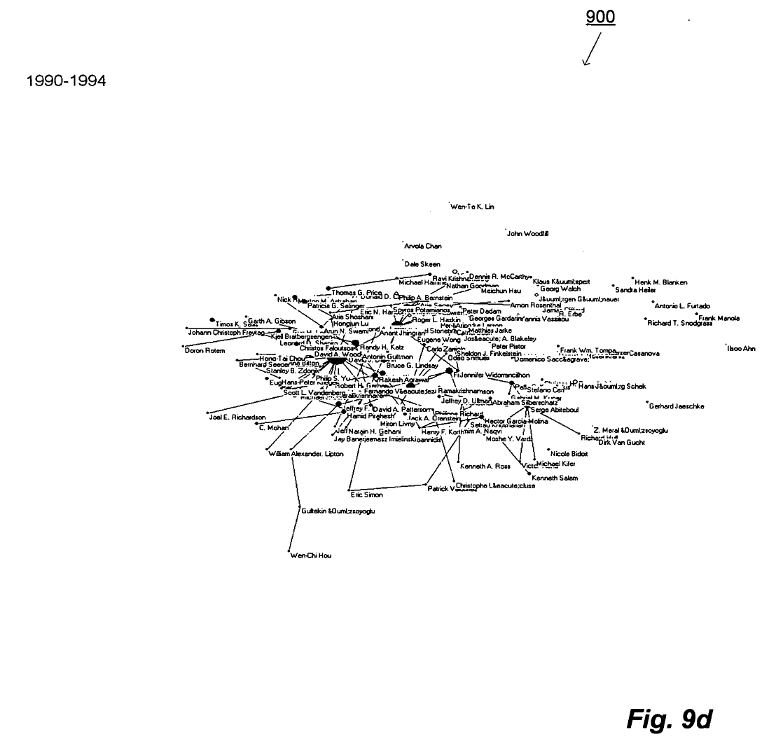

As with expertise relationships, by using these representation schemes and statistical analyses tools, embodiments may provide the capability for a user to identify various aspects of the experts' social relationships with respect to time. For example, embodiments may allow a user to observe the evolution of the social network over time. In this regard, in addition to studying the static network properties over a single twenty-five year period, the dynamic features of social networks may be observed over successive discrete periods of time. For example, the dataset spanning a twenty-five year period as described above may also be viewed as five successive five-year time segments. Similar to FIGS. 9a through 9e expertise reports 900, FIGS. 12a through 12e are example dynamic social reports 1200 from which a user may observe the top one hundred influential people for collaboration for each of the discrete time periods. In an embodiment, the dynamic social reports 1200 may be output to the user via a Graphical User Interface (GUI) using, for example, a computer display. By thus providing the user with an indication of how the social network changes over time, embodiments may output to the user an indication of the social network evolution. Referring to FIGS. 12a-12e, embodiments may also provide an indication of collaboration increasing for an expert over time as well as decreasing collaboration over time. For example, in at least one embodiment, darkened nodes 1201 may be used to represent increasing collaboration while lighter-colored nodes 1202 may be used to represent decreasing collaboration. Other representation schemes are possible. For example, in at least one embodiment, red nodes may be used to represent experts emerging in current time segment, white nodes used to represent experts disappearing from previous time segment, and blue nodes used to represent experts existing in both previous and current time segment. Alternatively, different symbols may be used to represent nodes having different properties. Links 1203 may represent the social relationship between experts. In an embodiment, the color or grayscale differences of links may have the same meaning as the color of the nodes.

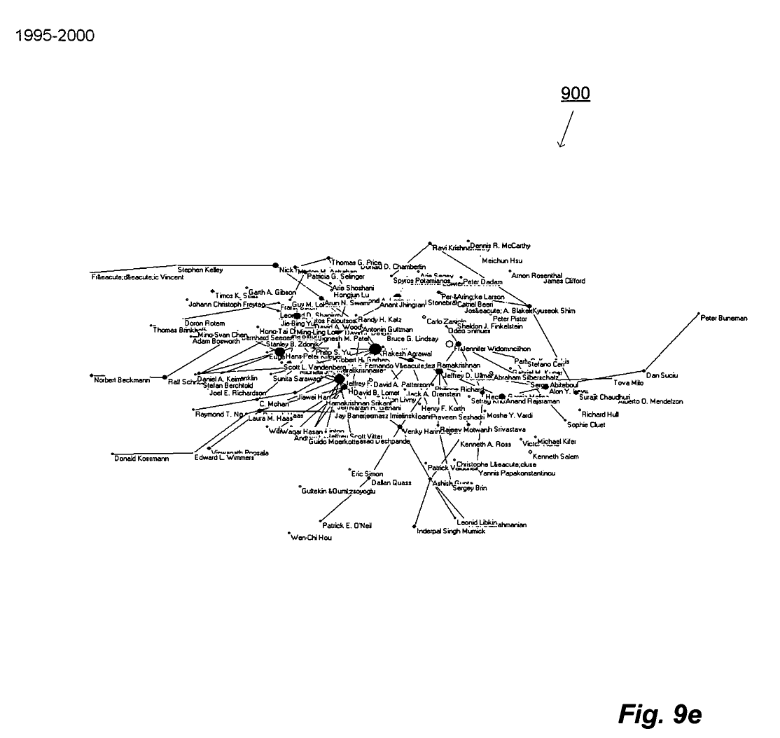

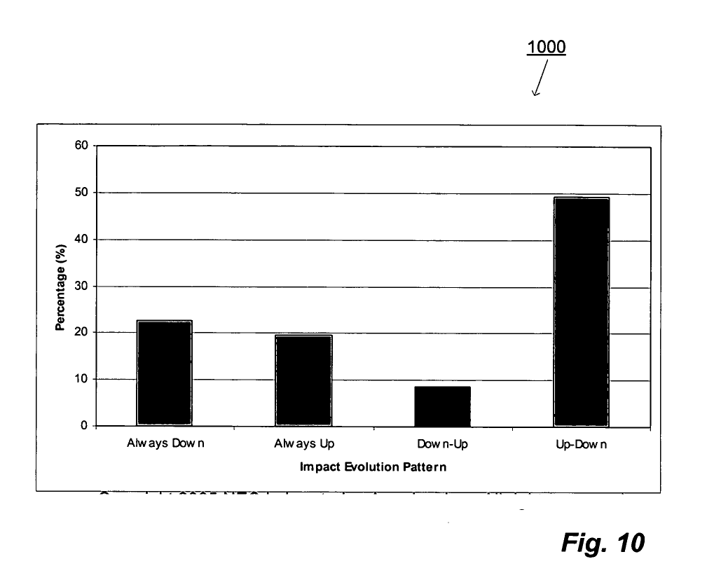

Furthermore, the network builder may also be configured to output a report indicating social network evolution statistics over time such as, for example, statistical analyses of the social network evolution for an entire community. FIG. 13 is an example dynamic social network report 1300 showing the collaboration range over time. FIG. 14 is an example dynamic social network report 1400 showing connection ties within and across the community over time. Embodiments may thereby provide another tool useful for evaluating social aspects of a person or group over time. For example, referring to FIGS. 13 and 14, it may be observed that the social network evolution in the example database community dataset has a number of interesting properties. First, the collaboration range becomes wider over time; that is, the number of authors per paper, the average collaborators per author and relative size of the largest cluster increases over time. Second, ties within small communities become stronger over time; that is, the collaboration closeness within communities (clustering coefficient) increases over time. Third, ties across communities do not become stronger; that is, the distance across communities (average separation) does not decrease over time. Based on these observations, a user may conclude that people in the database community tend to form small collaboration communities that have stronger ties over time. At the same time, although more collaboration appears across these small communities, collaboration across different communities does not form stronger ties over time.

Furthermore, factor analysis may be applied to the social network structure for each time segment (as discussed earlier with respect to FIGS. 9a-9e) to automatically detect one or more social network evolutionary points.

In an embodiment, the network builder 105 may be configured to build the expertise network and social network and to calculate network statistics as described with respect to 455 and 430 of FIG. 4 as well as FIGS. 7-14.

Returning to FIG. 4, following building the expertise network at 425 and the social network at 430, control may proceed to 435 at which the method may include forming a combined expertise-social network such as the expertise-social network 206. In at least one embodiment, the combined expertise-social network may include at least three kinds of information for each user: 1) an impact profile, 2) an expertise profile, and 3) a sociability profile. Embodiments that include the combined expertise-social network may support complicated expertise queries to allow a user to develop further knowledge of the person or group being evaluated.

In an embodiment, the network integrator and data analyzer 106 may allow a user query a dataset for detailed information such as, for example, a search of the reviewers of a publication such as a journal paper who have related expertise with the publication's author. Because expertise is represented in the form of an expertise profile, the network integrator and data analyzer 106 may build an expertise query profile designed to return a ranked list of experts having the desired features (e.g., authors having similar expertise) by comparing the query profile with each expert's expertise profile. For example, given a query expertise profile Q_{E}=<(e₁, e₂ . . . , eₙ), (q₁, q₂, . . . , qₙ), T_{Q}>, and a candidate expertise profile D_{E}=<(e₁, e₂ . . . , eₙ), (v₁, v₂, . . . , vₙ), T_{D}>, the relevance of query Q_{E} to D_{E} may be defined as:

$$Sim ( {Q}_{E} , {D}_{E} ) = \frac{{\sum }_{j = 1}^{n} {q}_{j} {v}_{j}}{\sqrt{{\sum }_{j = 1}^{n} {q}_{j}^{2}} \cdot \sqrt{{\sum }_{j = 1}^{n} {v}_{j}^{2}}} \times 1 \{ {T}_{Q} ⊆ {T}_{D} \} \qquad Eq . ( 7 )$$

Where (e₁, e₂ . . . , eₙ) is a set of expertise, each qᵢ is the expertise contribution to the i^{th} expertise eᵢ for the query expertise profile Q_{E} and T_{Q} is the time period of the query profile Q_{E}. Each vᵢ is the expertise contribution to the i^{th} expertise eᵢ for the candidate expertise profile D_{E} and T_{D} is the time period of the candidate expertise profile D_{E}. 1{.} is the indicator function (1{True}=1, 1 {False}=0). ⊂ represents the operator of “within”, which means the time period of candidate profile covers the time period of query profile.

Note that for searching the expertise match in a specific time segment, the candidate vectors have to cover the time period of the query vector Q(T_{Q}⊂T_{D}).

Embodiments may also provide the user with a ranked list of experts or expert recommendation based on the closeness of the fit to the desired expertise and also having high impact in the community. In at least one embodiment, the network integrator and data analyzer may be configured to integrate social evaluations with expertise evaluations in order to make the best recommendation. An approach to determine this combined evaluation may be as follows: Given a query profile Q_{E}=<(e₁, e₂ . . . , eₙ), (q₁, q₂ . . . , qₙ), T_{Q}>, a candidate expertise profile D_{E}=<(e₁, e₂ . . . , eₙ), (v₁, v₂, . . . , vₙ), T_{D}> and his impact profile D_{R}=<(e₁, e₂ . . . , eₙ), (r₁, r₂, . . . rₙ), T_{D}>, the relevance of query Q_{E} to D_{E} may be defined as:

$$Sim ( {Q}_{E} , ( {D}_{R} , {D}_{E} ) ) = \frac{{\sum }_{j = 1}^{n} {q}_{j} {v}_{j} {r}_{j}}{\sqrt{{\sum }_{j = 1}^{n} {q}_{j}^{2}} \cdot \sqrt{{\sum }_{j = 1}^{n} {v}_{j}^{2}}} \times 1 \{ {T}_{Q} ⊆ {T}_{D} \} \qquad Eq . ( 8 )$$

Where (e₁, e₂ . . . , eₙ) is a set of expertise, each qᵢ is the expertise contribution to the i^{th} expertise eᵢ for the query expertise profile Q_{E} and T_{Q} is the time period of the query profile Q_{E}. Each vᵢ is the expertise contribution to the i^{th} expertise eᵢ for the candidate expertise profile D_{E}, each rᵢ is the expertise impact to the i^{th} expertise eᵢ for the candidate impact profile D_{R} and T_{D} is the time period of the candidate expertise profile D_{E} and the impact profile D_{R}. 1{.} is the indicator function (1{True}=1, 1 {False}=0). ⊂ represents the operator of “within”, which means the time period of candidate profile covers the time period of query profile.

Furthermore, in at least one embodiment, the network integrator and data analyzer may be configured to search and return a ranked list of experts based on social linkages within a social radius. For example, embodiments may provide to the user the capability to search for reviewers who have collaborated with a particular author, using the social linkage in a sociability profile as follows: Given a query sociability profile Q_{S}=<(o₁, o₂ . . . , oₘ), (q₁, q₂ . . . , qₘ), T_{Q}>, a sociability profile Dₛ=<(o₁, o₂ . . . , oₘ), (n₁, n₂, . . . , nₘ), T_{D}>, the relevance of query Q_{S} to Dₛ may be defined as:

$$Sim ( {Q}_{S} , {D}_{S} ) = \frac{{\sum }_{j = 1}^{m} {q}_{j} {n}_{j}}{\sqrt{{\sum }_{j = 1}^{m} {q}_{j}^{2}} \cdot \sqrt{{\sum }_{j = 1}^{m} {v}_{j}^{2}}} \times 1 \{ {T}_{Q} ⊆ {T}_{D} \} \qquad Eq . ( 9 )$$

where (o₁, o₂ . . . , oₘ) is a set of collaborations, each qᵢ is the collaboration number with the i^{th} collaboration oᵢ for the query sociability profile Qₛ and T_{Q} is the time period of the query profile Qₛ. Each nᵢ is the collaboration number with the i^{th} collaboration oᵢ for the candidate sociability profile D_{S} and T_{D} is the time period of the candidate sociability profile D_{S}. 1{.} is the indicator function (1{True}=1, 1 {False}=0). ⊂ represents the operator of “within”, which means the time period of candidate profile covers the time period of query profile.

Furthermore, in at least one embodiment, control may then proceed to 440 at which the network integrator and data analyzer may use heuristics, for example a heuristic algorithm, to determine additional relationships, or metadata, among the items in a dataset. Further, the network integrator and data analyzer may also include using the metadata to influence the feature extraction such as, for example, the ranking of items based on impact profile at 420. In at least one embodiment, the network integrator and data analyzer may be configured to search and return a ranked list of experts based on expertise linkages and social linkages between the experts. For example, embodiments may provide to the user the capability to search for reviewers of a publication such as a journal paper who have related expertise with this publication's author, and have no conflict of interest. In an embodiment, this may be accomplished by matching the query against the expertise profile in its expertise profile and checking the social linkage in a sociability profile. The final match may then be evaluated based on a linear combination of their expertise and sociability match result. That is, the relevance of an author to a given query may depend not only on the similarity of the query to the user's expertise, but also on the constraint assigned to sociability. For example, given a query Q with expertise profile Q_{E} and social profile Qₛ, the relevance of Q to a candidate's profile D may be computed as:
Sim(Q,D)=β*Sim(Q_{E},(D_{R},D_{E}))+(1−β)*Sim(Qₛ,D_{S}) Eq. (10)

where D_{E} is the expertise profile in author's profile D, D_{S} is the sociability profile in author's profile D, D_{R} is the impact profile in author's profile D, and β is the weight associated with expertise profile.

In addition, statistical methods may be applied to the expertise linkages and social linkages jointly to identify relationships among dependent variables associated with the information represented. For example, relationships identified using the expertise network and social network may be correlated using statistics described herein such as, for example: the impact of an author as described with respect to FIG. 6; publication number; collaboration degree as described for social network statistics, and; average publication standard (i.e., what level of conference for which the author prefers to publish) according to the following:

$$\frac{{\sum }_{i = 1}^{Pub\_num} {C}_{i}}{pub\_num} \qquad Eq . ( 11 )$$

where pub_num is the total number of publications for the author; Cᵢ is the conference impact for the i^{th} publication.

Statistics may also include the citation ratio (average # of citations per publication) according to the following:
# citations/# publications Eq. (12)

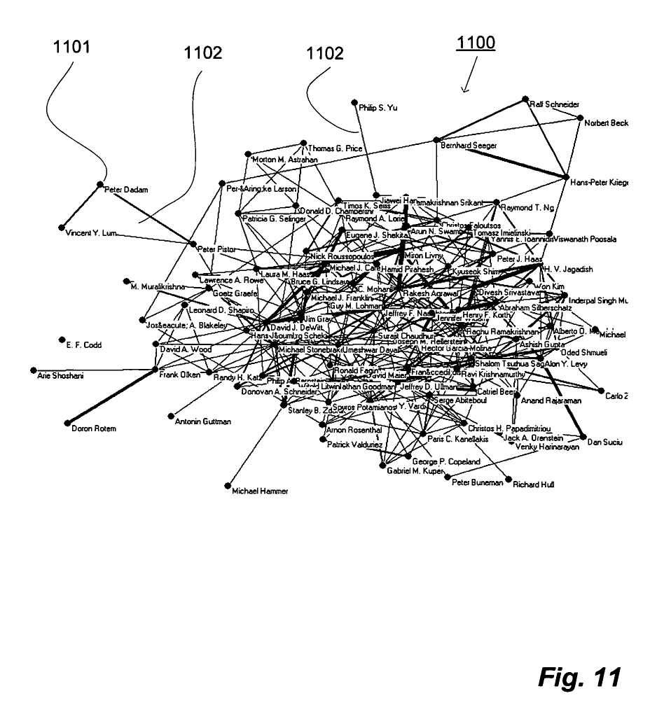

This capability to correlate both expertise features and social features provides the user with a tool to predict a future trend indicating whether a candidate is well-suited to a particular working situation or environment such as, for example, being a successful contributor in a technical team. For example, the FIGS. 15a and 15b are example output reports 1500 showing the correlation statistics for a population of one hundred heavily cited authors versus one hundred lightly cited authors, respectively. In particular, FIGS. 15a and 15b include statistics associated with both commonality and difference in expertise and social behavior correlation. From FIGS. 15a and 15b, the following observations can be made: First, there is a low correlation between “impact” and “average publication standard” and between “impact” and “citation ratio,” from which it may implied that people became famous in the community because of having authored several high quality publications.

Second, there is a high correlation between “publication number” and “collaboration degree,” which means that people who have a large number of publications tend to have more citations. Third, compared to lightly cited people, heavily cited people tend to have higher publication numbers and collaboration degree. Thus, the systems and methods of the embodiments described herein may include systems and methods relating to building a expertise networks and social networks that account for both expertise and social relationships, analyzing expertise and social network evolution correlation, and predicting future trends related thereto. Embodiments may include an expertise-social network combination that captures and analyzes both the expertise relationship of a person or group of interest as well as the social relationship among the person or group. Embodiments may also include a system and methods to provide statistics- and learning-based network analysis to detect expertise and social network evolution patterns, find the correlation between expertise and social behavior, make recommendations for recruiting or reviewing, and predict new trends for the whole community or individual's future behavior based on evolution pattern analysis.

While embodiments of the invention have been described above, it is evident that many alternatives, modifications and variations will be apparent to those skilled in the art. In general, embodiments may relate to the automation of these and other business processes in which feature extraction and analysis of a data corpus is performed. For example, embodiments as discussed herein may be applied to an electronic mail database or corpus to provide the user with an indication of the relative ranking of an individual based on the application of heuristics to relationships identified in the electronic mail dataset. The dataset may include, for example, the electronic mail messages to, from, and within an organization such as a company. An impact profile may be determined for each individual that takes into consideration a number of concepts such as, for example, the number of electronic mail messages sent by the individual related to a particular topic, the number of electronic mail messages received by the individual related to the topic, the frequency of appearance of the individual in electronic mail messages sent by other individuals on the topic, the number of mailing lists upon which the individual appears, and so on. Thus, embodiments may allow a user to search, identify, and evaluate relatively the individual expertise existing in an organization for a particular field or topic.

As another example, embodiments may include a system and methods for analyzing data to determine recommendations for technical reviewers of papers to be presented at a conference or in a journal. In these embodiments, the system and methods described herein may be used to evaluate reviewers that have related expertise but do not have conflicts of interest. Similar embodiments may include a system and methods for evaluating persons for committee selection, experts to testify at trial, and so on, using the network integrator and data analyzer described herein.

In a further example, embodiments may include a system and methods for analyzing or ranking case law decisions. In such embodiments, the number of times a particular decision is cited in subsequent judicial opinions may be represented using a first network and analyzed using a statistical approach as described herein to determine, for example, the impact of one or more decisions. Further, differences in the authority of the citing opinions (e.g., U.S. Supreme Court, state supreme court, circuit court, appellate court) may be taken into account in determining a relative ranking of case law decisions, in analogy to the quality of citing publications as described earlier herein. In addition, a second network may be used to represent and serve as a basis for statistical analysis of social aspects such as, for example, the number of times a particular judge or justice has agreed with other judges/justices in a panel (or en banc), or has disagreed (e.g., dissented). This characteristic may be analogized to the collaboration analysis described earlier herein. Other data relationships may be represented and analyzed as well. Furthermore, another embodiment may include a system and methods for analyzing or ranking job applications for non-technical positions. Other embodiments are possible for representing and analyzing data relationships.

In a still further example, embodiments may include a system and methods for accessory assembly. In these embodiments, the system and methods described herein may be used to evaluate the relative suitability of multiple candidate products or accessories, based on their product attributes or data, that have related functionality, along with each product/accessory's relationships to other assemblies and with respect to related products. Other criteria may be used as well, including availability in inventory, product life cycle, accessory cost, maintenance costs, and so on.

In a still further example, embodiments may relate to homeland security applications in which feature extraction and analysis of a data corpus is performed. For example, embodiments as discussed herein may be applied to financial transaction records in a database or corpus to provide the user with an indication of the relative ranking of individuals or institutions based on the application of heuristics to relationships identified in the dataset. An impact profile may be determined for each individual or institution that takes into consideration a number of concepts such as, for example, the number of transactions initiated by the individual/institution, the number of transactions involving the individual/institution, the number of charitable organizations with which the individual is associated, the size and frequency of financial transactions involving the individual/institution, the frequency by location of transactions involving the individual/institution, and so on.

Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

We claim:

1. A computer-implemented method comprising:
generating one or more nodes using feature extraction from a dataset, wherein each node represents a concept; and
determining at least a first relationship among the nodes;
wherein the generating is accomplished based on heuristics using the first relationship.

2. The method of claim 1, wherein the heuristics includes an impact profile.

3. The method of claim 2, further comprising:
generating the impact profile for each of a plurality of items based on information associated with the items obtained from the dataset;
generating an expertise profile for each of the plurality of items based on the impact profile; and
outputting a report representing the contents of the impact profile and expertise profile, wherein the report indicates a relative ranking of the items based on the contents of the impact profile and the expertise profile.

4. The method of claim 3, wherein the generating one or more nodes is accomplished by forming a query to extract items having a candidate profile most nearly matching the expertise profile.

5. The method of claim 3, further comprising:
determining a second relationship between the nodes based on metadata associated with the items in the dataset.

6. The method of claim 5, further comprising:
generating a social profile for each of the plurality of items based on the second relationship;
wherein the impact profile is formed as a linear combination of the first relationship and the second relationship; and
wherein the report represents the contents of the impact profile, the expertise profile, and the social profile, and wherein the ranking is based on the contents of the impact profile, the expertise profile, and the social profile.

7. The method of claim 6, wherein the generating one or more nodes is accomplished by forming a query to extract items having a candidate profile most nearly matching a linear combination of the expertise profile and the social profile.

8. The method of claim 7, in which the linear combination is defined as:
Sim(Q,D)=β*Sim(Q_{E},(D_{R},D_{E}))+(1−β)*Sim(Qₛ,D_{S}).

9. The method of claim 3, wherein the expertise profile is based on a citation ratio computed as the number of citations to authors contained in publications associated with a conference divided by the number of publications associated with the conference.

10. The method of claim 9, wherein the expertise profile is also based on a publication impact determined by the quality of the conference with which the paper is associated, as well as an expert impact determined by the number of times the expert is cited and the quality of the citing publications.

11. A computer-implemented method comprising:
generating a set of nodes by extracting features from a dataset according to at least a first heuristic;
representing at least a first feature relationship using the nodes, a second feature relationship using a first link, and a third feature relationship using a second link, wherein each of said first and second links has an endpoint at one of the nodes;
assigning a weight for each link based on a second heuristic;
ranking the nodes based on the first and second heuristics; and
outputting a report including an indication of the ranking.

12. The method of claim 11, in which the first heuristic is an impact profile generated for each expert based on the number of links and their quality weighting associated with the expert.

13. The method of claim 11, in which the second heuristic is an expertise social network score.

14. The method of claim 12, wherein the first link represents a first relationship among publications and authors.

15. The method of claim 14, wherein the first link is a citation link for which each instance represents a citation of the expert by a publication or a citation by another publication of a publication associated with the expert.

16. The method of claim 15, wherein the second link is a co-author link for which each instance represents co-authorship of a publication by the expert.

17. The method of claim 16, wherein the third link is a co-citation link for which each instance represents citation by a publication of the expert along with other experts.

18. The method of claim 11, wherein the ranking is based on an expertise social profile.

19. The method of claim 18, wherein the ranking is based on an expert impact determined from both the number of publications citing the expert and the quality of the citing publications.

20. The method of claim 11, wherein the report includes a visual representation of a network formed from the nodes and links.

21. A system comprising:
a feature extractor configured to obtain information from a dataset;
an impact analyzer configured to analyze extracted feature information to produce an impact ranking;
a network builder configured to construct at least a first and a second network, wherein each network is a representation of a different set of relationships among dataset items; and
a network integrator and data analyzer configured to perform analysis using a combination of the at least first and second networks and the impact ranking based on at least one relationship determined to exist between items in the dataset according to heuristics.

22. The system of claim 21, wherein the first network is constructed to identify at least one expertise relationship and the second network is constructed to identify at least one social relationship.

23. The system of claim 21, wherein the network builder is further configured to analyze of the information represented by each of the first network and the second network.

24. The system of claim 23, wherein the network builder is further configured to perform the analysis separately over discrete periods of time and to output an indication of the network evolution with respect to the analysis results over time based on the results determined for each discrete time period.

25. The system of claim 22, wherein the at least one social relationship is collaboration.

26. The system of claim 21, wherein the network integrator and data analyzer is further configured to perform the analysis separately over discrete periods of time and to output an indication of the combined network evolution with respect to the analysis results over time based on the results determined for each discrete time period.

27. The system of claim 26, wherein the network integrator and data analyzer is further configured to identify evolutionary points.
